(19) United States
(12) Patent Application Publication
(10) Pub. No.: US 2025/0243106 A1
(43) Pub. Date: Jul. 31, 2025

(54) OPTICAL FIBER PREFORM AND METHOD OF MANUFACTURING OPTICAL FIBER PREFORM

(71) Applicant: FURUKAWA ELECTRIC CO., LTD., Tokyo (JP)

(72) Inventor: Yuki SATO, Tokyo (JP)

(73) Assignee: FURUKAWA ELECTRIC CO., LTD., Tokyo (JP)

(21) Appl. No.: 19/014,669

(22) Filed: Jan. 9, 2025

(30) Foreign Application Priority Data
Jan. 29, 2024 (JP) 2024-011094

(51) Int. Cl. C03B 37/014; C03B 37/012

(52) U.S. Cl. CPC C03B 37/01446; C03B 37/0124; C03B 2207/70

(57) ABSTRACT

The present invention intends to suppress variation in characteristics in the longitudinal direction of the optical fiber preform. The method of manufacturing method of manufacturing an optical fiber preform including forming a core by blowing a first raw material gas from a core burner to a starting base material, and forming a first clad by blowing a second raw material gas from a clad burner to the core, after forming the first clad, forming a second clad by blowing a third raw material gas from the clad burner to an end portion of the core, forming a core rod by heating the first clad and the second clad, and forming a third clad on an outer periphery of the core rod.

### BACKGROUND OF THE INVENTION

### Field of the Invention

The present invention relates to an optical fiber preform and a method of manufacturing the optical fiber preform.

### Description of the Related Art

As a method of manufacturing an optical fiber preform, a vaper phase axial deposition (VAD) method is widely known (Japanese Patent Application Laid-Open No. 2017-226569). In the VAD method, glass fine particles are blown from a burner onto a starting base material while the starting base material is pulled up, a soot which is a deposit of glass fine particles is formed. The VAD method has an advantage that it is easy to increase the size of the optical fiber preform.

In general, in the method of manufacturing the optical fiber base material, it is widely performed that the sintering of the end region of the soot proceeds more than the sintering of the middle region of the soot during soot formation in order to suppress cracks in the end region of the soot.

### SUMMARY OF THE INVENTION

However, the composition of the clad in the end region of the soot may be changed by making the sintering of the end region of the soot proceed more than the sintering of the middle region of the soot. This may vary the characteristics of the optical fiber preform in the longitudinal direction and deteriorate the characteristics of the optical fiber preform.

An object of the present invention is to provide a method of manufacturing an optical fiber preform capable of suppressing variation in characteristics in the longitudinal direction of the optical fiber preform.

According to one aspect of the present invention, provided is a method of manufacturing an optical fiber preform including forming a core by blowing a first raw material gas from a core burner to a starting base material, and forming a first clad by blowing a second raw material gas from a clad burner to the core, after forming the first clad, forming a second clad by blowing a third raw material gas from the clad burner to an end portion of the core, forming a core rod by heating the first clad and the second clad, and forming a third clad on an outer periphery of the core rod.

According to another aspect of the present invention, provided is an optical fiber preform including a core and a clad covering the core. A variation in the fluorine content in a longitudinal direction of the clad is smaller than or equal to 0.05 wt %.

According to the present invention, it is possible to provide a method of manufacturing an optical fiber preform capable of suppressing variation in characteristics in the longitudinal direction of the optical fiber preform.

### BRIEF DESCRIPTION OF THE DRAWINGS

FIG. 1 is a cross-sectional view of an optical fiber preform according to one embodiment.

FIG. 2 is a graph illustrating a refractive index of the optical fiber preform according to one embodiment.

FIG. 3 is a schematic diagram of a VAD apparatus according to one embodiment.

FIG. 4 is a flowchart of a method of manufacturing the optical fiber preform according to one embodiment.

FIG. 5 is a graph illustrating a relative refractive index difference in a longitudinal direction of the optical fiber preform.

### DESCRIPTION OF THE EMBODIMENTS

Embodiments according to the present invention will be described below with reference to the drawings. Throughout the drawings, components having the same function are labeled with the same references, and the repetitive description thereof will be omitted.

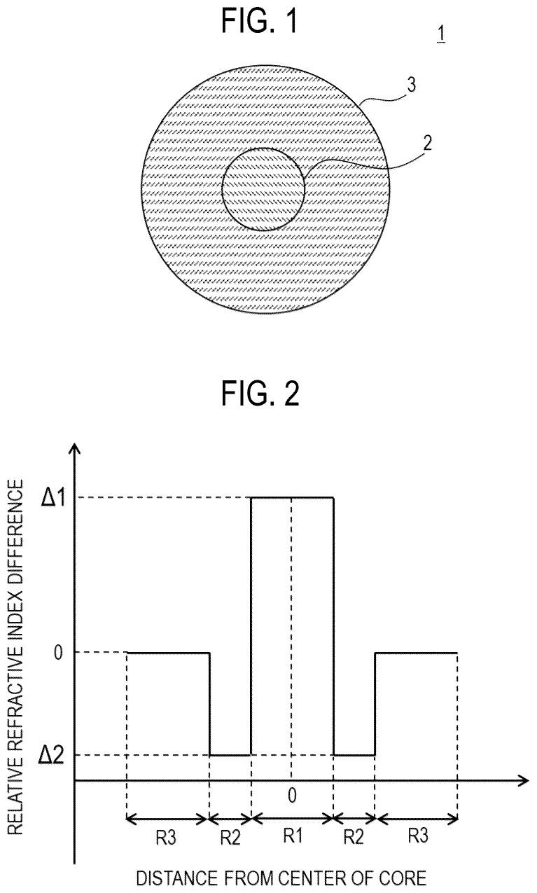

FIG. 1 is a cross-sectional view of an optical fiber preform according to the present embodiment. The optical fiber preform 1 includes a core 2 and a clad 3. The optical fiber preform 1 may be made of quartz glass. The optical fiber preform 1 is composed of a porous body (soot) which is a deposit of glass fine particles. The soot is manufactured by a VAD apparatus described below.

The core 2 is a central portion of the optical fiber preform 1 and extends in the longitudinal direction of the optical fiber preform 1. The core 2 is made of, for example, quartz-based glass doped with a dopant such as germanium, and has a refractive index higher than that of pure quartz-based glass. The refractive index of the core 2 is set higher than the refractive index of the clad 3, and light transmitted through the core 2 is totally reflected at the interface between the core 2 and the clad 3. Thus, light transmitted through the core 2 can be prevented from leaking to the clad 3, and the light can be confined in the core 2.

The clad 3 covers the outer periphery of the core 2 and extends in the longitudinal direction of the optical fiber preform 1. The clad 3 is made of, for example, quartz-based glass doped with a dopant such as fluorine, and has a refractive index lower than that of pure quartz-based glass. The clad 3 includes an inner clad covering the outer periphery of the core 2 and an outer clad covering the inner clad. The refractive index of the inner clad is set lower than the refractive index of the outer clad, and light transmitted through the core 2 can be more strongly confined.

FIG. 2 is a graph illustrating the refractive index of the optical fiber preform 1 according to the present embodiment. In FIG. 2, the vertical axis represents a relative refractive index difference with respect to the outer clad, and the horizontal axis represents the distance in the radial direction of the optical fiber preform 1 from the center of the core 2.

In FIG. 2, a region R1 represents the relative refractive index difference of the core 2, a region R2 represents the relative refractive index difference of the inner clad, and a region R3 represents the relative refractive index difference of the outer clad. The core 2 has the relative refractive index difference Δ1 larger than 0. The relative refractive index difference Δ1 is preferably, for example, larger than or equal to 0.3% and smaller than or equal to 0.5%. The relative refractive index difference Δ1 changes depending on the germanium content of the core 2. The inner clad has the relative refractive index difference Δ2 less than 0. The relative refractive index difference Δ2 is preferably, for example, larger than or equal to −0.15% and smaller than or equal to −0.03%. The relative refractive index difference Δ2 changes depending on the fluorine content of the clad 3.

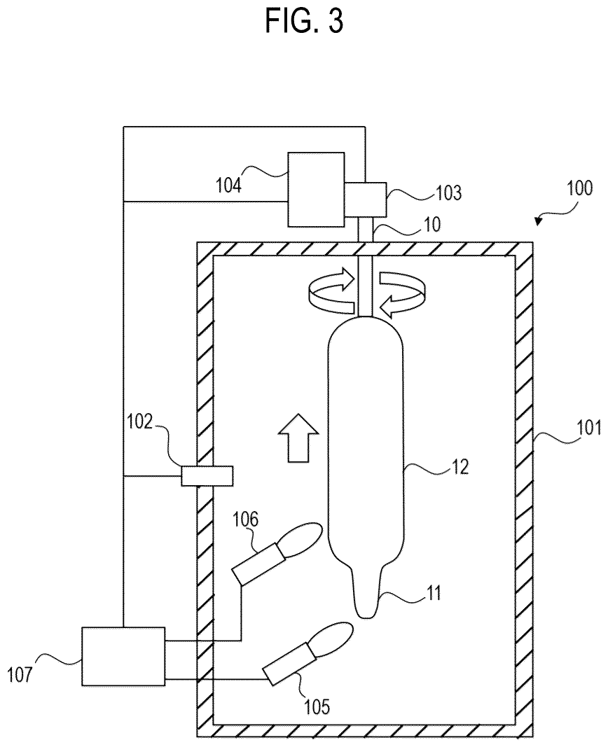

FIG. 3 is a schematic diagram of the VAD apparatus 100 according to the present embodiment. The VAD apparatus 100 includes a housing 101, an exhaust unit 102, a rotating unit 103, a driving unit 104, a first burner 105, a second burner 106, and a control unit 107. The VAD apparatus 100 sequentially manufactures an intermediate 11 and a soot 12 from a starting base material 10 that is a raw material of the optical fiber preform 1.

The housing 101 has a box shape including a side wall, a ceiling, and a bottom wall. Although the housing 101 may be made of robust metal, the material of the housing 101 is not limited to any particular material. The starting base material 10 is accommodated in the housing 101. The starting base material 10 is made of, for example, quartz-based glass.

The exhaust unit 102 is provided on the side wall of the housing 101. The exhaust unit 102 includes a pump and a valve (not shown), and exhausts gases generated from the first burner 105 and the second burner 106 to the outside of the housing 101.

One end of the starting base material 10 is connected to the rotating unit 103. The rotating unit 103 includes a chuck, a motor, and the like, and rotates the starting base material 10 while being held by the chuck. The rotating unit 103 is connected to the driving unit 104. The driving unit 104 may include a motor or the like. The driving unit 104 can move the starting base material 10 in the upward direction (longitudinal direction) by raising the rotating unit 103. The driving unit 104 may include a displacement meter that measures the amount of movement of the starting base material 10 in the longitudinal direction.

The first burner 105 is provided in the housing 101 so as to face the starting base material 10. The first burner 105 is provided in front of the second burner 106 with respect to the moving direction of the starting base material 10. The first burner 105 may be a multi-tube burner. The number of first burners 105 is not limited to the example of FIG. 3 and may be selected to any number.

The first burner 105 includes a nozzle for supplying a flame forming gas and a nozzle for supplying a raw material gas (first raw material gas) of the core 2. The flame forming gas may include a combustible gas such as hydrogen, a supporting gas such as oxygen, and the like. The raw material gas of the core 2 may include silicon tetrachloride, germanium tetrachloride, phosphoryl chloride, and boron bromide. Silicon tetrachloride is a raw material of glass. Germanium tetrachloride is a dopant for increasing the refractive index of glass. The relative refractive index difference Δ1 in the optical fiber preform 1 can be changed by adjusting the flow rate of germanium tetrachloride in the raw material gas of the core 2.

The first burner 105 ejects an oxyhydrogen flame by combustion of hydrogen and oxygen. When the raw material gas of the core 2 is supplied to the oxyhydrogen flame, the raw material gas of the core 2 is flame hydrolyzed, and glass fine particles forming the core 2 are generated. The glass fine particles forming the core 2 are blown onto the starting base material 10 which rises and rotates inside the housing 101. The intermediate 11 is formed by depositing the glass fine particles forming the core 2 on the starting base material 10.

The second burner 106 is provided in the housing 101 so as to face the starting base material 10. The second burner 106 may be a multi-tube burner. The number of second burners 106 is not limited to the example of FIG. 3 and may be selected to any number. The second burner 106 may also take the form of a burner array in which a plurality of second burners 106 are integrated.

The second burner 106 includes a nozzle for supplying a flame forming gas and a nozzle for supplying the raw material gas of the clad 3. The flame forming gas may include a combustible gas such as hydrogen, a supporting gas such as oxygen, and the like. The raw material gas of the clad 3 may include silicon tetrachloride and silicon tetrafluoride. Silicon tetrafluoride is a dopant for lowering the refractive index of glass. The relative refractive index difference Δ2 in the optical fiber preform 1 can be changed by adjusting the flow rate of silicon tetrafluoride in the raw material gas of the clad 3.

By supplying the raw material gas of the clad 3 to the oxyhydrogen flame of the second burner 106, the raw material gas of the clad 3 is subjected to flame hydrolysis, and glass fine particles forming the clad 3 are generated. The glass fine particles forming the clad 3 are blown onto the intermediate 11 which rises and rotates inside the housing 101. The soot 12 is formed by depositing the glass fine particles forming the clad 3 around the intermediate 11.

The control unit 107 controls the exhaust unit 102, the rotating unit 103, the driving unit 104, the first burner 105, and the second burner 106. The control unit 107 may control, for example, the exhaust air volume of the exhaust unit 102, the rotation speed of the starting base material 10 of the rotation unit 103, the moving speed of the driving unit 104 in the longitudinal direction of the starting base material 10, the flow rate of silicon tetrachloride of the first burner 105, the flow rate of germanium tetrachloride of the first burner 105, the flow rate of silicon tetrachloride of the second burner 106, the flow rate of germanium tetrachloride of the second burner 106, and the flow rate of silicon tetrafluoride of the second burner 106.

The control unit 107 may change the manufacturing conditions for each position in the longitudinal direction of the starting base material 10. For example, since the end region of the soot 12 is discarded during the manufacturing process, germanium tetrachloride is not supplied to the first burner 105 for the intermediate 11 corresponding to the end region of the soot 12. As a result, the amount of germanium used in the manufacture of the soot 12 can be reduced. When the raw material gas of the clad 3 supplied to the second burner 106 in the middle region of the soot 12 is the second raw material gas and the raw material gas of the clad 3 supplied to the second burner 106 in the end region of the soot 12 is the third raw material gas, the flow rate of silicon tetrafluoride in the third raw material gas is controlled to be greater than the flow rate of silicon tetrafluoride in the second raw material gas. The end region of the soot 12 may change with the overall longitudinal length of the soot 12. For example, the end region of the soot 12 may be a region of larger than or equal to 5 cm and smaller than or equal to 20 cm from the lower end of the soot 12. The middle region of the soot 12 may be the entire region of the soot 12 excluding the end region of the soot 12.

At the time of manufacturing the soot 12, the soot 12 is heated by a burner (not shown), and voids between the glass fine particles of the soot 12 are reduced by sintering. As a result, the volume of the soot 12 is reduced, and a core rod having a high density is obtained.

Sintering of the end region of the soot 12 proceeds more than sintering of the middle region of the soot 12. For example, by setting the heating temperature of the end region of the soot 12 to be higher than the heating temperature of the middle region of the soot 12, or by setting the heating time of the end region of the soot 12 to be longer than the heating time of the middle region of the soot 12, sintering of the end region of the soot 12 may proceed more than sintering of the middle region of the soot 12. Since the glass fine particles forming the core 2 have a higher density than the glass fine particles forming the clad 3, cracks may occur in the soot 12 due to the density difference between the core 2 and the clad 3 during the manufacture of the soot 12. Further, in the end region of the soot 12, the glass fine particles forming the clad 3 are deposited from the end portion of the intermediate 11, and the glass fine particles forming the clad 3 are deposited more than in the middle region of the soot 12. Therefore, cracks in the soot 12 are likely to occur in the end region of the soot 12. By sintering of the end region of the soot 12 proceeds more than the sintering of the central region of the soot 12, the density of the clad 3 in the end region of the soot 12 can be increased, and cracks in the soot 12 can be suppressed. When the glass fine particles forming the clad 3 are deposited from the end portion of the intermediate 11, the deposition of the glass fine particles forming the core 2 may be stopped or may be stopped while gradually decreasing. Accordingly, the use of expensive germanium tetrachloride included in the glass fine particles forming the core 2 can be reduced, and the manufacturing cost can be reduced.

The core rod is heated and stretched, and the glass fine particles forming the clad 3 are deposited on the core rod by an outside vaper deposition (OVD) method. After the glass fine particles forming the clad 3 are deposited to a desired thickness, the core rod is heated to form the optical fiber preform 1. The optical fiber preform is drawn by a drawing apparatus to form a bare optical fiber. An optical fiber is obtained by coating a resin around the bare optical fiber.

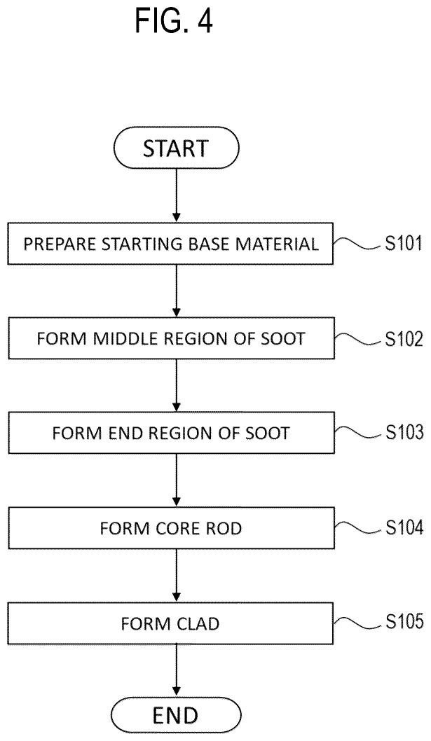

FIG. 4 is a flowchart of a method of manufacturing the optical fiber preform 1. First, the starting base material 10 is prepared in the VAD apparatus 100 (step S101).

Next, the first burner 105 blows the glass fine particles forming the core 2 generated from the first raw material gas to the starting base material 10, and the second burner 106 blows the glass fine particles forming the clad 3 (first clad) generated from the second raw material gas to the starting base material 10. Thus, a middle region of the soot 12 is formed (step S102).

Next, the second burner 106 blows the glass fine particles forming the clad 3 (second clad) generated from the third raw material gas to the end portion of the intermediate 11. Thus, an end region of the soot 12 is formed (step S103). Here, the flow rate of silicon tetrafluoride in the third raw material gas is greater than the flow rate of silicon tetrafluoride in the second raw material gas. In this way, the soot 12 is manufactured from the starting base material 10.

Next, the soot 12 is heated to form a core rod (step S104). Next, after the glass fine particles forming the clad 3 (third clad) are deposited to a desired thickness on the outer periphery of the core rod by the OVD method, the core rod is heated (step S105). Thus, the optical fiber preform 1 is formed.

In the manufacture of the soot 12, the sintering of the end regions of the soot 12 proceeds more than the middle region of the soot 12, and the density of the end regions of the soot 12 is higher than the density of the middle region of the soot 12. When the density of the soot 12 increases, the silicon tetrafluoride in the soot 12 is less likely to be doped into the clad 3. As a result, silicon tetrafluoride in the end region of the soot 12 diffuses into the middle region of the soot 12. As a result, the fluorine content in the end region of the soot 12 becomes lower than that in the middle region of the soot 12, and a variation in the relative refractive index difference Δ2 in the longitudinal direction of the optical fiber preform 1 may occur.

In the present embodiment, by appropriately setting the flow rate of silicon tetrafluoride with respect to the longitudinal direction of the soot 12, the variation in the characteristics in the longitudinal direction of the optical fiber preform 1 is suppressed. Specifically, the flow rate of silicon tetrafluoride in the third raw material gas is set to be greater than the flow rate of silicon tetrafluoride in the second raw material gas. Thus, the fluorine content in the end region of the soot 12 is larger than the fluorine content in the middle region of the soot 12, and the fluorine content in the end region of the soot 12 is prevented from becoming too low due to diffusion of silicon tetrafluoride into the middle region of the soot 12.

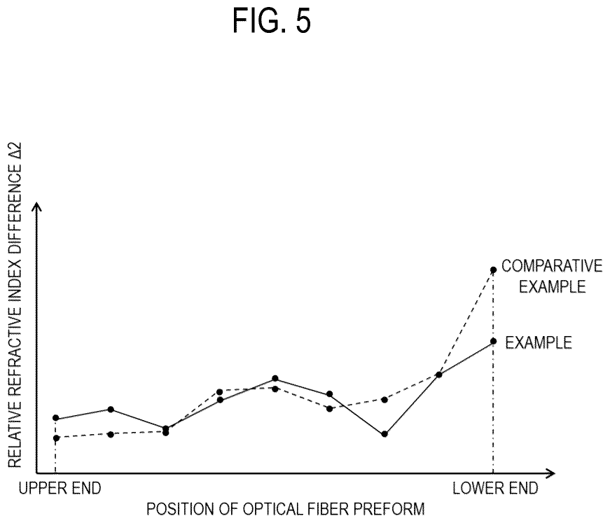

FIG. 5 is a graph illustrating a relative refractive index difference Δ2 in the longitudinal direction of the optical fiber preform 1. In FIG. 5, the vertical axis represents the relative refractive index difference Δ2, and the horizontal axis represents the position of the optical fiber preform 1 in the longitudinal direction with respect to the upper end of the optical fiber preform 1. The upper end of the optical fiber preform 1 is the upper end of the middle region of the soot 12, and the lower end of the optical fiber preform 1 is the lower end of the end region of the soot 12. The optical fiber preform 1 in the Example is manufactured by making the flow rate of silicon tetrafluoride in the end region of the soot 12 greater than the flow rate of silicon tetrafluoride in the middle region of the soot. The optical fiber preform 1 in the Comparative Example is manufactured without changing the flow rate of silicon tetrafluoride between the end region of the soot 12 and the middle region of the soot 12. As described above, due to the diffusion of silicon tetrafluoride in the end region of the soot 12, the relative refractive index difference Δ2 in the end region of the optical fiber preform 1 becomes larger than the relative refractive index difference Δ2 in the middle region of the optical fiber preform 1. As illustrated in FIG. 5, the variation in the relative refractive index difference Δ2 in the longitudinal direction of the optical fiber preform 1 in the Example is smaller than that of the optical fiber preform 1 in the Comparative Example. Therefore, by making the flow rate of silicon tetrafluoride in the end region of the soot 12 greater than the flow rate of silicon tetrafluoride in the middle region of the soot 12, it is possible to suppress the variation in the relative refractive index difference Δ2.

In the present embodiment, the flow rate of silicon tetrafluoride in the third raw material gas is preferably greater than or equal to 1.3 times and less than or equal to 1.9 times the flow rate of silicon tetrafluoride in the second raw material gas. When the flow rate is smaller than 1.3 times, the influence of diffusion of silicon tetrafluoride into the middle region of the soot 12 cannot be sufficiently reduced. When the flow rate exceeds 1.9 times, the fluorine content in the end region of the soot 12 becomes too high, and a variation in the relative refractive index difference Δ2 may occur.

Hereinafter, experimental results of the optical fiber preform according to the embodiment of the present invention will be described.

TABLE 1

| | | Increase rate | Variation | |
|---|---|---|---|---|
| | | of silicon | in relative | |
| | | tetrafluoride | refractive index | |
| | Soot density | flow rate | difference Δ2 | Evaluation |
| | g/cm³ | % | % | — |
| Example 1 | 0.285 | 30 | 0.002 | OK |
| Example 2 | 0.285 | 60 | 0.0015 | OK |
| Example 3 | 0.285 | 80 | 0.001 | OK |
| Example 4 | 0.285 | 90 | 0.0008 | OK |
| Example 5 | 0.25 | 30 | 0.0019 | OK |
| Example 6 | 0.25 | 60 | 0.0016 | OK |
| Example 7 | 0.25 | 80 | 0.001 | OK |
| Example 8 | 0.25 | 90 | 0.0008 | OK |
| Example 9 | 0.3 | 30 | 0.002 | OK |
| Example 10 | 0.3 | 60 | 0.0015 | OK |
| Example 11 | 0.3 | 80 | 0.001 | OK |
| Example 12 | 0.3 | 90 | 0.0008 | OK |
| Example 13 | 0.35 | 30 | 0.0021 | OK |
| Example 14 | 0.35 | 60 | 0.0015 | OK |
| Example 15 | 0.35 | 80 | 0.001 | OK |
| Example 16 | 0.35 | 90 | 0.001 | OK |
| Comparative | 0.285 | 20 | 0.005 | NG |
| Example 1 | | | | |
| Comparative | 0.25 | 20 | 0.005 | NG |
| Example 2 | | | | |
| Comparative | 0.3 | 20 | 0.005 | NG |
| Example 3 | | | | |
| Comparative | 0.35 | 20 | 0.005 | NG |
| Example 4 | | | | |

Table 1 shows the soot density (g/cm³), the increase rate (%) of the silicon tetrafluoride flow rate of the raw material gas in the end region of the soot with respect to the silicon tetrafluoride flow rate of the raw material gas in the middle region of the soot, the variation (%) in the relative refractive index difference Δ2 in the longitudinal direction of the optical fiber preform, and evaluation regarding the variation in the relative refractive index difference Δ2 in the longitudinal direction of the optical fiber preform in Examples 1 to 16 and Comparative Examples 1 to 4. In Examples and Comparative Examples, the soot density was measured using X-ray CT examination. In Examples and Comparative Examples, the relative refractive index difference Δ2 was measured at intervals of 200 mm in the longitudinal direction of the optical fiber preform, and the variation in the relative refractive index difference Δ2 was measured by subtracting the minimum value from the maximum value of the relative refractive index difference Δ2.

The Evaluation in Table 1 shows whether or not the variation in the relative refractive index difference Δ2 satisfies the standard (smaller than or equal to 0.0021%). When the variation in the relative refractive index difference Δ2 satisfies the standard, the evaluation is judged to be good, and when the variation in the relative refractive index difference Δ2 does not satisfy the standard, the evaluation is judged to be poor.

In Examples 1 to 4, the soot density was 0.285 g/cm³. The increase rate of the flow rate of silicon tetrafluoride was 30%, 60%, 80%, and 90%, respectively. The variation in the relative refractive index difference Δ2 was 0.002%, 0.0015%, 0.001%, and 0.0008%, respectively. In Examples 1 to 4, the variation in the relative refractive index difference Δ2 was smaller than or equal to 0.00218, and the Evaluation was good (OK).

In Examples 5 to 8, the soot density was 0.25 g/cm³. The increase rate of the flow rate of silicon tetrafluoride was 30%, 60%, 80%, and 90%, respectively. The variation in the relative refractive index difference Δ2 was 0.0019%, 0.0016%, 0.001%, and 0.0008%, respectively. In Examples 5 to 8, the variation in the relative refractive index difference Δ2 was smaller than or equal to 0.0021%, and the Evaluation was good (OK).

In Examples 9 to 12, the soot density was 0.3 g/cm³. The increase rate in the flow rate of silicon tetrafluoride was 30%, 60%, 80%, and 90%, respectively. The variation in the relative refractive index difference Δ2 was 0.002%, 0.0015%, 0.001%, and 0.0008%, respectively. In Examples 9 to 12, the variation in the relative refractive index difference Δ2 was smaller than or equal to 0.0021%, and the Evaluation was good (OK).

In Examples 13 to 16, the soot density was 0.35 g/cm³. The increase rate of the flow rate of silicon tetrafluoride were 30%, 60%, 80%, and 90%, respectively. The variation in the relative refractive index difference Δ2 was 0.0021%, 0.0015%, 0.001%, and 0.0008%, respectively. In Examples 9 to 12, the variation in the relative refractive index difference Δ2 was smaller than or equal to 0.0021%, and the Evaluation was good (OK).

In Comparative Example 1, the soot density was 0.285 g/cm³. The increase rate of the silicon tetrafluoride flow rate was 20%. The variation in the relative refractive index difference Δ2 was 0.005%. In Comparative Example 1, the variation in the relative refractive index difference Δ2 was larger than 0.0021%, and the Evaluation was poor (NG).

In Comparative Example 2, the soot density was 0.25 g/cm³. The increase rate of the silicon tetrafluoride flow rate was 20%. The variation in the relative refractive index difference Δ2 was 0.005%. In Comparative Example 2, the variation in the relative refractive index difference Δ2 was larger than 0.00218, and the Evaluation was poor (NG).

In Comparative Example 3, the soot density was 0.3 g/cm³. The increase rate of the silicon tetrafluoride flow rate was 20%. The variation in the relative refractive index difference Δ2 was 0.005%. In Comparative Example 3, the variation in the relative refractive index difference Δ2 was larger than 0.00218, and the Evaluation was poor (NG).

In Comparative Example 4, the soot density was 0.35 g/cm³.

The increase rate of the silicon tetrafluoride flow rate was 20%. The variation in the relative refractive index difference Δ2 was 0.005%. In Comparative Example 4, the variation in the relative refractive index difference Δ2 was larger than 0.00218, and the Evaluation was poor (NG).

TABLE 2

| | Upper end | Middle | Lower end | |
|---|---|---|---|---|
| | region of | region of | region of | Variation |
| | optical | optical | optical | in |
| | fiber | fiber | fiber | fluorine |
| | preform | preform | preform | content |
| | wt % | wt % | wt % | wt % |
| Example | 0.44 | 0.43 | 0.43 | 0.01 |
| Comparative | 0.41 | 0.39 | 0.30 | 0.11 |
| Example | | | | |

Table 2 shows the fluorine content (wt %) in the upper end region of the optical fiber preform, the fluorine content (wt %) in the middle region of the optical fiber preform, the fluorine content (wt %) in the lower end region of the optical fiber preform, and the variation (wt %) in the fluorine content in Example and Comparative Example. The variation in the fluorine content in Table 2 is calculated by subtracting the minimum value from the maximum value of the fluorine content in each of the upper end region, the middle region, and the lower end region of the optical fiber preform. In Table 2, quantitative analysis of the fluorine content in the clad of the optical fiber preform was measured.

With respect to the soot of the optical fiber preform in Examples, the flow rate of silicon tetrafluoride in the raw material gas forming the end region of the soot was greater than or equal to 1.3 times and less than or equal to 1.9 times the flow rate of silicon tetrafluoride in the middle region of the soot. For the soot of the optical fiber preform in the Comparative Example, the flow rate of silicon tetrafluoride in the raw material gas forming the end region of the soot is not changed with respect to the flow rate of silicon tetrafluoride in the middle region of the soot.

In the Example, the fluorine content in the upper end region of the optical fiber preform was 0.44 wt %. The fluorine content in the middle region of the optical fiber preform was 0.43 wt %. The fluorine content in the lower end region of the optical fiber preform was 0.43 wt %. The variation in the fluorine content was 0.01 wt %.

In the Comparative Example, the fluorine content in the upper end region of the optical fiber preform was 0.41 wt %. The fluorine content in the middle region of the optical fiber preform was 0.39 wt %. The fluorine content in the lower end region of the optical fiber preform was 0.30 wt %. The variation in the fluorine content was 0.11 wt %.

As described above, by increasing the flow rate of silicon tetrafluoride in the end region of the soot with respect to the flow rate of silicon tetrafluoride in the middle region of the soot, it is possible to suppress variation in the fluorine content in the longitudinal direction of the optical fiber preform. The variation in the fluorine content in the longitudinal direction of the optical fiber preform may be preferably smaller than or equal to 0.05 wt %.

The present invention is not limited to the embodiments described above, and various modifications are possible. For example, an example in which a part of the configuration of any of the embodiments is added to another embodiment or an example in which a part of the configuration of any of the embodiments is replaced with a part of the configuration of another embodiment is also an embodiment of the present invention. In addition, a known technique or a known technique in the technical field can be appropriately applied to a specific description or a portion not illustrated in the embodiments.

What is claimed is:

1. A method of manufacturing an optical fiber preform comprising:
forming a core by blowing a first raw material gas from a core burner to a starting base material, and forming a first clad by blowing a second raw material gas from a clad burner to the core;
after forming the first clad, forming a second clad by blowing a third raw material gas from the clad burner to an end portion of the core;
forming a core rod by heating the first clad and the second clad; and
forming a third clad on an outer periphery of the core rod.

2. The method of manufacturing the optical fiber preform according to claim 1, wherein a flow rate of silicon tetrafluoride in the third raw material gas is greater than a flow rate of silicon tetrafluoride in the second raw material gas.

3. The method of manufacturing the optical fiber preform according to claim 1, wherein a flow rate of silicon tetrafluoride in the third raw material gas is greater than or equal to 1.3 times and less than or equal to 1.9 times a flow rate of silicon tetrafluoride in the second raw material gas.

4. The method of manufacturing the optical fiber preform according to claim 1, wherein in forming the second clad, the third raw material gas is blown to a region of larger than or equal to 5 cm and smaller than or equal to 20 cm from the end portion of the core.

5. The method of manufacturing the optical fiber preform according to claim 1,
wherein a density of the soot formed in forming the first clad and forming the second clad is larger than or equal to 0.25 g/cm³ and smaller than or equal to 0.35 g/cm³, and
wherein a flow rate of silicon tetrafluoride in the third raw material gas is greater than or equal to 1.3 times and less than or equal to 1.9 times a flow rate of silicon tetrafluoride in the second raw material gas.

6. The method of manufacturing the optical fiber preform according to claim 1,
wherein a density of the soot formed in forming the first clad and forming the second clad is larger than or equal to 0.25 g/cm³ and smaller than or equal to 0.35 g/cm³, and
wherein a flow rate of silicon tetrafluoride in the third raw material gas is greater than or equal to 1.6 times and less than or equal to 1.9 times a flow rate of silicon tetrafluoride in the second raw material gas.

7. The method of manufacturing the optical fiber preform according to claim 1,
wherein a density of the soot formed in forming the first clad and forming the second clad is larger than or equal to 0.25 g/cm³ and smaller than or equal to 0.35 g/cm³, and
wherein a flow rate of silicon tetrafluoride in the third raw material gas is greater than or equal to 1.6 times and less than or equal to 1.8 times a flow rate of silicon tetrafluoride in the second raw material gas.

8. The method of manufacturing the optical fiber preform according to claim 1, wherein a variation in a relative refractive index difference in a longitudinal direction of the optical fiber preform is smaller than 0.0021%.

9. The method of manufacturing the optical fiber preform according to claim 1, wherein in forming the core rod, the first clad and the second clad are heated such that sintering of the second clad proceeds more than sintering of the first clad.

10. A method of manufacturing an optical fiber comprising:
drawing the optical fiber preform manufactured by the method of manufacturing the optical fiber preform according to claim 1 to form a bare optical fiber; and
coating a resin around the bare optical fiber.

11. An optical fiber preform comprising:
a core; and
a clad covering the core,
wherein a variation in the fluorine content in a longitudinal direction of the clad is smaller than or equal to 0.05 wt %.
